(19) United States
(12) Patent Application Publication
(10) Pub. No.: US 2022/0187614 A1
(43) Pub. Date: Jun. 16, 2022

(54) Reduced Speckle Illumination Systems And Methods

(71) Applicants: LIFE TECHNOLOGIES CORPORATION, Carlsbad, CA (US); LIFE TECHNOLOGIES HOLDINGS PTE LTD, Singapore (SG)

(72) Inventors: Michael D Ward, Eugene, OR (US); Gregory Kaduchak, Chandler, AZ (US); Lingzhi ZHU, Singapore (SG)

(21) Appl. No.: 17/549,114

(22) Filed: Dec. 13, 2021

Related U.S. Application Data
(60) Provisional application No. 63/125,259, filed on Dec. 14, 2020.
(60) Provisional application No. 63/287,335, filed on Dec. 8, 2021.

(51) Int. Cl. G02B 27/48; F21V 8/00; G02B 6/44; G02B 6/028

(52) U.S. Cl. CPC G02B 27/48; G02B 6/0288; G02B 6/4457; G02B 6/0008

(57) ABSTRACT

Provided are laser sources, the laser sources comprising at least one diode; and an optic fiber of a predefined length disposed between the laser source and a position for a target such that the optic fiber communicates light pulses from the laser source as a source light to the position for the target, wherein the position is illuminated by the source light so as to reduce speckles in a captured image of the target. Also provided are methods for providing source light for generating an image, comprising: generating illumination with one or more laser diodes; and passing the illumination through an optic fiber having a plurality of bends therein such that source light is emitted from the optic fiber so as to illuminate a target with the source light, the source light reducing speckles in an image of the target.

### RELATED APPLICATIONS

The present application claims priority to and the benefit of U.S. patent application No. 63/125,259, “Reduced Speckle Illumination Systems and Methods ” (filed Dec. 14, 2020) and U.S. patent application No. 63/287,335, “Reduced Speckle Illumination Systems and Methods” (filed Dec. 8, 2021). The foregoing applications are incorporated herein in their entireties for any and all purposes.

### TECHNICAL FIELD

The present disclosure relates to the field of laboratory illumination systems.

### BACKGROUND

Historically, speckle in conventional imaging has been addressed by averaging out many different speckle patterns during the camera exposure. Such solutions are, however, active in nature and also occur in the time domain, as they operate by generating a multitude of speckle patterns and averaging the result over time. Some examples of the these approaches include vibrating a fiber optic, passing light through a spinning disk of ground glass, and passing light through a spinning collection of optical fibers.

A spinning disk can be, e.g., 2 inches in diameter, spun at 50,000 rpm, and have a displacement velocity at the disk edge of 10 micrometers/100 ns. This arrangement, however, requires a significant amount of hardware, which can add to the complexity and footprint of a low-speckle instrument. Vibration used to effect multimode illumination can be in the range of tens of Hz to tens of kHz, and a 10 ns pulse can require a vibration frequency of more than 10 MHz, as displacement is proportional to 1/frequency. A vibration-based approach, however, can introduce undesired hardware complexity.

Although the foregoing approaches can be effective at speckle reduction in certain cases, the foregoing approaches also occur on timescales of milliseconds, which makes the solutions poorly suited to the short exposure times necessary for flow cytometry. Accordingly, there is a long-felt need in the art for speckle reduction systems and methods that are suitable for use in flow cytometry applications, in particular systems and methods that effect speckle reduction on a time scale suited to flow cytometry.

### SUMMARY

In meeting the described long-felt needs, the present disclosure first provides light sources for capturing an image, the light sources comprising: a laser source, the laser source comprising at least one diode; and an optic fiber disposed so as to communicate light pulses having a plurality of modes between the laser source and a target position so as to reduce speckles in a captured image of a target at the target position, at least some of the optic fiber being present in one or more layers wrapped about a spindle, the spindle optionally comprising circumferential walls between which circumferential walls optic fiber is wound, a layer comprising at least one taut winding of the optical fiber.

Also provided are methods, comprising operating a light source according to the present disclosure (e.g., according any one of Aspects 1-21) to illuminate a target.

Further provided methods, comprising placing an optic fiber into optical communication with a source of illumination such that the optic fiber is placed so as to communicate light from the source of illumination to a target disposed at a target location, at least some of the optic fiber being present in one or more layers wrapped about a spindle, the spindle optionally comprising circumferential walls between which optic fiber is wound, anda layer comprising at least one taut winding of the optical fiber.

Also provided are methods for providing source light for generating an image, comprising: generating illumination with one or more laser diodes; and passing the illumination through an optic fiber being present in one or more layers wrapped about a spindle, the spindle optionally comprising circumferential walls between which optic fiber is wound, and a layer comprising at least one taut winding of the optical fiber,the passing performed such that multimode source light is emitted from the optic fiber so as to illuminate a target with the illumination light, the illumination reducing speckles in an image of the target.

Further disclosed are cytometers, comprising: a flow cell configured to contain one or more particles therein, the flow cell defining a target region; an illumination train comprising at least (1) a laser source that includes at least one diode and (2) an optic fiber in optical communication with the laser source, at least some of the optic fiber being present in one or more layers wrapped about a spindle, the spindle optionally comprising circumferential walls between which circumferential walls optic fiber is wound, and a layer comprising at least one taut winding of the optical fiber.

Further disclosed are imagers, comprising: a sample zone configured to contain a sample therein; an illumination train comprising at least (1) a laser source that includes at least one diode and (2) an optic fiber in optical communication with the laser source, at least some of the optic fiber being present in one or more layers wrapped about a spindle, the spindle optionally comprising circumferential walls between which circumferential walls optic fiber is wound, and a layer comprising at least one taut winding of the optical fiber; and an image capture device configured to capture an image of a sample disposed within the sample zone region while illuminated by illumination from the at least one diode communicated through the optic fiber, the imager further optionally comprising a movement train configured to effect relative motion between the sample within the sample zone and illumination from the at least one diode communicated through the optic fiber.

Further provided are light sources, comprising: a laser source, the laser source comprising at least one diode; and an optical fiber disposed so as to communicate light between the laser source and an imaging plane so as to lower coherence of the light so as to reduce speckle at the imaging plane, at least some of the optical fiber being bent about a support so as to give rise to a mechanical tension within the optical fiber.

Also provided are methods, comprising operating a light source according to the present disclosure (e.g., a light source according to any one of Aspects 47-74).

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various aspects discussed in the present document. In the drawings:

FIG. 1 provides an exemplary illustration of single mode and multimode illumination communicated through various optical fibers;

FIG. 2 provides an exemplary image of a 10 micrometer bead illuminated by a 10 ns pulse of illumination communicated through a 2 m optical fiber;

FIG. 3 provides an illustrative depiction of speckle contrast as a function of the length of the fiber through which illumination is communicated;

FIG. 4 provides a view of an exemplary laser assembly according to the present disclosure, showing multiple laser diodes in optical communication with an optical fiber;

FIG. 5 provides a view of (left) a bead illuminated by a 100 ns pulse of illumination communicated through a 2 m optical fiber and (right) a comparable bead illuminated by a 100 ns pulse of illumination communicated through a 50 m optical fiber; and

FIG. 6 provides an illustration of an exemplary system according to the present disclosure.

FIG. 7 provides (left panel) a view of a tightly wound fiber spool and (right panel) a view of a loosely wound fiber spool.

FIG. 8 provides a view of fiber spool in which fiber is wound over another fiber loop, with the result being a bulge in the fiber wound over the inner fiber loop.

FIG. 9 provides a view of (left panel) a layer of neatly wound fiber and (right panel) a layer of randomly wound fiber, showing the resultant fiber crossovers.

FIG. 10 provides a view of an exemplary fiber winding arrangement.

FIG. 11 provides a cutaway view of layers of fiber in a spool of wound fiber.

FIG. 12 provides an image of a loosely-wound fiber spool (right panel) and an image (left pane) collected by that loosely-wound fiber spool.

FIG. 13 provides an image of a tightly-wound fiber spool (right panel) and an image (left panel) collected by that tightly-wound fiber spool.

FIG. 14 provides images produced by different fibers that were wound by the techniques described in this disclosure, showing the consistency and repeatability of this technique.

FIG. 15 provides a view of a technique for fabricating wound fibers according to the present disclosure, showing the take-up of optical fiber by a custom spool that is fed the optical fiber by a supplier spool.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints, 2 grams and 10 grams, and all the intermediate values). The endpoints of the ranges and any values disclosed herein are not limited to the precise range or value; they are sufficiently imprecise to include values approximating these ranges and/or values.

As used herein, approximating language can be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

With the advancing development of CMOS sensors that provide higher speeds and quantum efficiencies, cameras are becoming more amenable to flow cytometry applications. Coupled with the advancement of high-power laser diodes and the resultant reduction in price per watt of optical power, combining high-speed cameras with laser sources is a compelling approach for use in flow cytometry imaging. The effectiveness of such an approach, however, can be compromised somewhat by the presence of unwanted laser speckle in images collected by the camera.

To reduce this unwanted speckle, the present disclosure provides, inter alia, the use of optical fiber to deliver multimode illumination to a target, which multimode illumination in turn reduces speckle in imaging of that target.

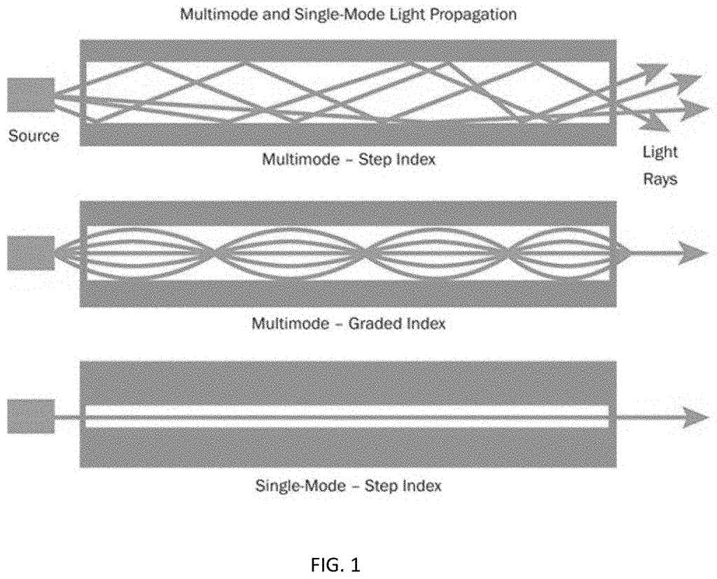

Multimode illumination can be effected in a number of ways, e.g., with multimode fiber. A multimode fiber can contain thousands or even tens of thousands of propagation modes. Each mode possesses a different spatial path during propagation, as shown in FIG. 1 attached hereto. This can result in a temporal spread of the light at the fiber output. As a crude description for speckle reduction, the different modes can be envisioned as many different sources, which in turn creates different speckle patterns.

In addition to geometric mode spreading, one can effect additional perturbations to the fiber and/or excitation that can increase coupling to higher order modes. For example, increasing the angle of the cone of excitation light entering the fiber can increase modal coupling. This can couple light into higher order modes that propagate at larger angles within the fiber. For this reason, fibers with relatively higher numerical aperture and higher order mode numbers can be used. As a non-limiting example, fibers having numerical aperture values of, e.g., from about 0.2 to about 0.55 can be used. To further mix the modes and access higher orders, curving, coiling, or otherwise bending the optic fiber can have the effect of bending light from lower modes to higher modes over long distances.

Source bandwidth can mix modes even further. Different wavelengths have different modal patterns thereby creating different mode structures across an array of wavelengths. For this reason, one can use sources (e.g., laser diodes) of multiple modes, e.g., a first diode that emits at a first wavelength and a second diode that emits at a second wavelength. One can also use a multimode diode, e.g., a diode that lases at multiple wavelengths.

In existing approaches, relatively short optical fibers are used, over which short lengths, passive modal mixing is small and inefficient at reducing speckle in images. As described elsewhere herein, some techniques use vibration or movement to deform fiber optic cable, thereby creating and then accessing more geometric modes for use in averaging a multitude of speckle patterns.

Most applications can afford to vibrate a fiber on a time scale of milliseconds as most conventional microscope techniques use exposure times of tens to hundreds of milliseconds. For the high-speed imaging required in flow cytometry, however, modal mixing must be accomplished within a time window in the neighborhood of 100 nanoseconds, which is orders of magnitude shorter than the suitable time windows for convention microscopy. This comparatively short time window thus precludes the use in flow cytometry of most of the current active speckle reduction techniques.

In the present disclosure, the properties of the multimode fiber are used for an ultra-high-speed speckle reduction technique. This can be accomplished by using the slow mode mixing/pulse spreading properties of a multimode fiber coupled with the listed additive perturbations to increase modal mixing. In this embodiment, one can use fiber lengths and laser wavelength bandwidths that differ from those encountered in standard imaging applications.

High-speed speckle reduction can be accomplished by using each of the techniques listed above to increase passive modal mixing. Independently the mixing is not adequate, but by moving the parameters out of the current norm and combining the techniques, adequate speckle reduction can be achieved on very short time scales.

In one embodiment, a relatively long (e.g., 50 m in length) multimode, high numeric aperture fiber is inserted between the light source and imaging target. The fiber can be wound around a spindle to have a continuous bend that can allows access to further modes. In addition, source bandwidth can be increased by coupling light from multiple laser diodes at slightly different wavelengths into the fiber. Each of these effects is additive.

Figures

The appended figures are illustrative only and do not necessarily limit the scope of the present disclosure or the appended claims.

FIG. 1 provides an exemplary illustration of single mode and multimode illumination communicated through various optical fibers—single mode/step index; multimode/graded index, and multimode/step index.

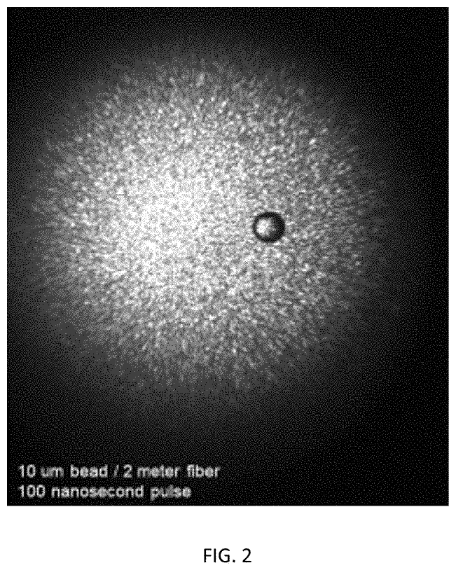

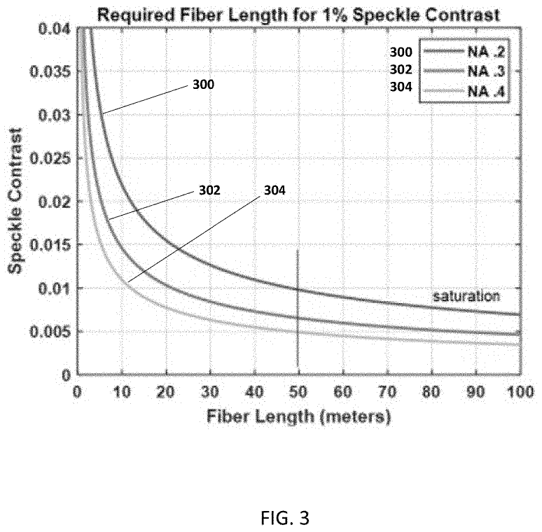

FIG. 2 provides an exemplary image of a 10 micrometer bead illuminated by a 10 ns pulse of illumination communicated through a 2 m optical fiber; FIG. 3 provides an illustrative depiction of speckle contrast as a function of the length of the fiber through which illumination is communicated. As shown, the NA of the fiber (0.2—corresponding to line 300; 0.3—corresponding to line 302; and 0.4—corresponding to line 304) can affect the speckle contrast evolved as a function of fiber length. As an example, at a fiber length of 50 m, a fiber with an NA of 0.4 exhibits a comparatively lower speckle contrast as compared to a fiber with an NA of 0.2.

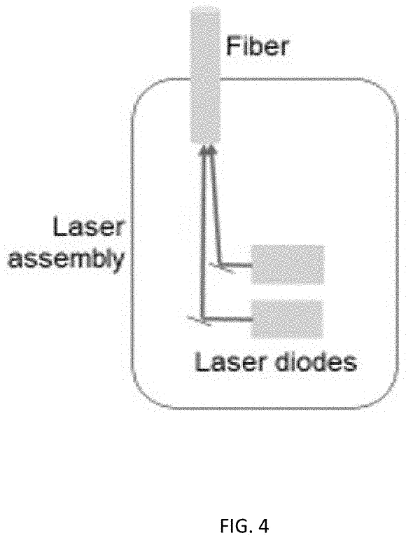

FIG. 4 provides a view of an exemplary laser assembly according to the present disclosure. As shown, an assembly can include multiple laser diodes in optical communication with an optical fiber.

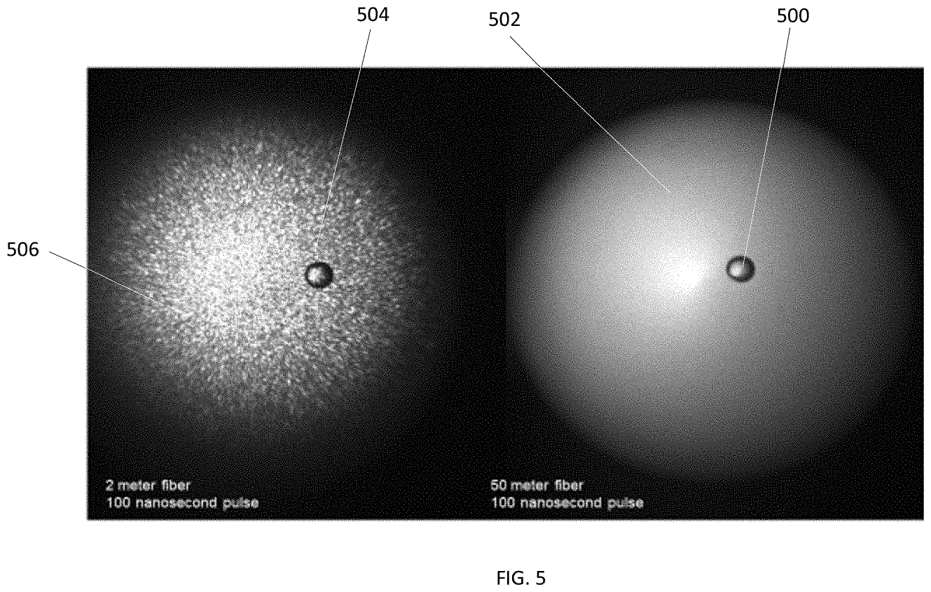

FIG. 5 provides a view of (left) a 10 micron bead 504 moving at 4 m/s within background 506 and illuminated by a 100 ns pulse of illumination communicated through a 2 m multimode optical fiber; and of (right) a comparable bead 500 (moving within background 502) illuminated by a 100 ns pulse of illumination communicated through a 50 m multimode optical fiber that was wrapped around a spindle; both fibers have an NA of 0.5. Multiple laser diodes near 405 nm wavelength were used to illuminate the fiber. with high NA of 0.5 and 50 m length. A light pulse synchronized between the multiple diodes of approximately 100 nanoseconds was used to strobe the target, and the exposure time was about 6 microseconds. As seen, the use of the disclosed approach resulted in a marked difference (right panel) over a comparative approach (left panel).

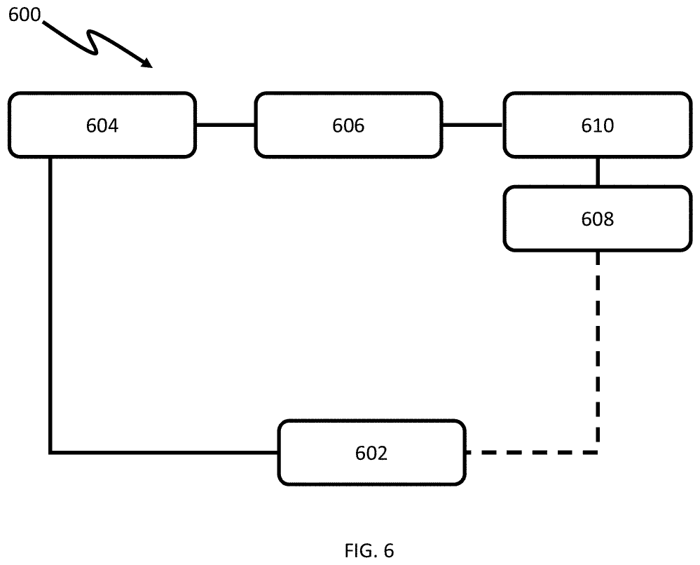

FIG. 6 provides an illustration of an exemplary system according to the present disclosure. As shown, a system 600 can include a controller 602, which controller can be in communication with one or more laser diodes 604; a diode can be a single-mode or a multimode diode. The laser diodes 604 can be in communication with optic fiber 606, which fiber can be a multimode fiber. Fiber 606 can also be wrapped about a spindle (or multiple spindles) and can also be otherwise curved or bent. Illumination delivered from fiber 606 can be delivered to sample location 610, e.g., a flow cell, a microscope stage, or other location where a sample is illuminated. An image capture train 608 in turn captures an image of the sample illuminated at sample location 610, which image exhibits a reduced speckle. Controller 602 can be in communication with image capture train 608, although this is not a requirement, as image capture train can be in communication with an alternate controller.

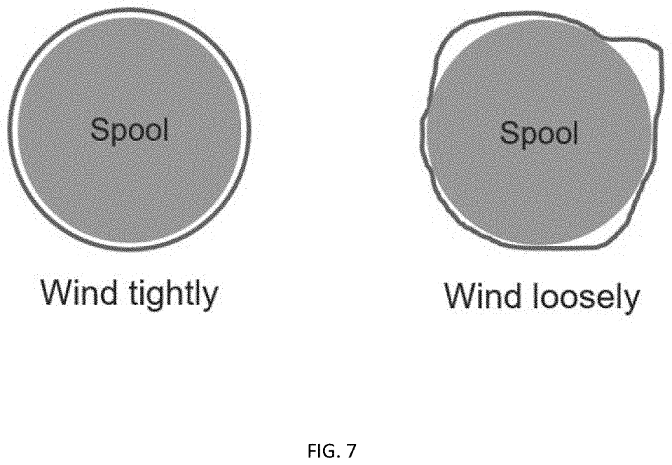

FIG. 7 provides (left panel) a view of a tightly wound fiber spool and (right panel) a view of a loosely wound fiber spool. As shown, the loosely-wound fiber does not have a consistent radius around its circumference. Without being bound to any particular theory or embodiment, winding the fiber tightly produces a constant bending radius such that only certain order of propagation modes are retained within the fiber core. By contrast, when the fiber is loosely wound spool or there is slack in the fiber, the bending radius of the fiber is not well-controlled, and light can be coupled into different order modes other than the desired modes.

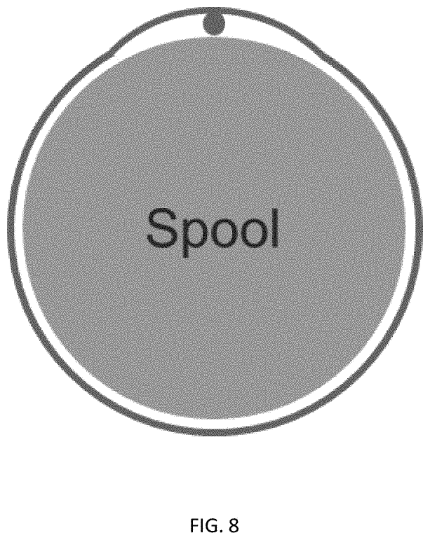

FIG. 8 provides a view of fiber spool in which fiber is wound with a “cross-over” over another fiber loop, with the result being a bulge in the fiber wound over the inner fiber loop. Without being bound to any particular theory or embodiment, having such a cross-over can result in a non-uniform radius for the fiber; winding the fiber over another loop of fiber can introduce a different bending radius which can result in generating different order modes. Thus, when fiber is wound neatly around the spindle or spool, such winding reduces the number of crossovers and avoids having small bends of different radiuses which can in some instances propagate higher order modes and or reduce fiber transmission.

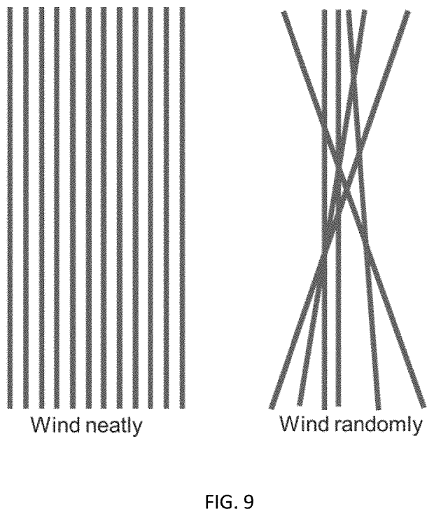

FIG. 9 provides a view of (left panel) a layer of neatly wound fiber and (right panel) a layer of randomly wound fiber, showing the resultant fiber crossovers. As illustrated in FIG. 8, the presence of such a crossover (of which there are several in FIG. 9), can result in a non-uniform or inconsistent fiber radius.

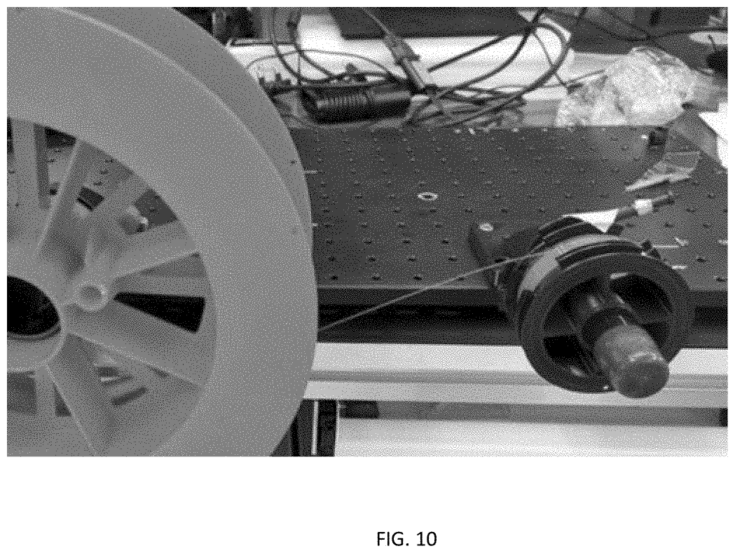

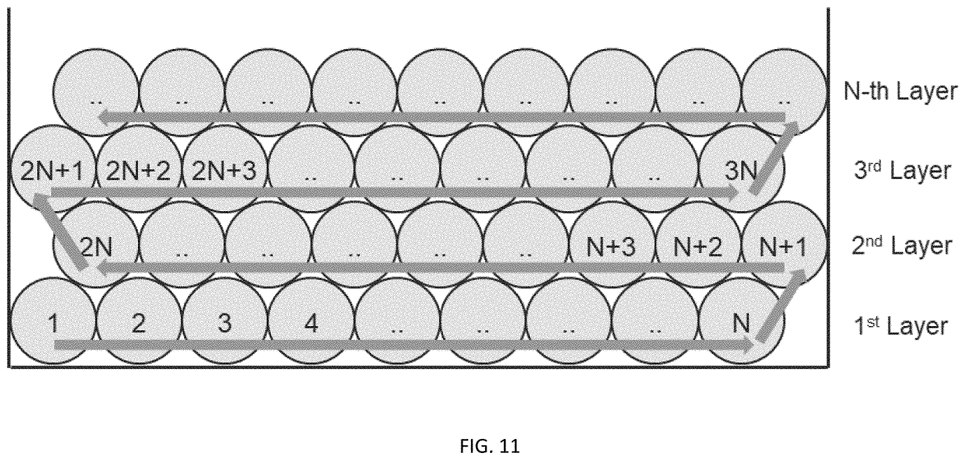

FIG. 10 provides a view of an exemplary fiber winding arrangement. Without being bound to any particular theory or embodiment, fiber can be wrapped about a spindle in a roll-to-roll approach; with the fiber source and/or the spindle that takes up the fiber rotating circumferentially and the source and/or takeup spindle moving axially so as to achieve a fiber wrapping that is free or essentially free of cross-overs, as shown in FIG. 8. Fiber windings can be arranged in a side-to-side winding pattern, as shown in, e.g., FIG. 11.

FIG. 11 provides a cutaway view of layers of fiber in a spool of wound fiber. As shown, a given layer of fiber can have as many windings as the layer beneath or above that given layer, although this is not a requirement.

In FIG. 11, the numbers in the circles refer to the nth loop of the winding process. The two vertical lines refer to the walls on the spool. The winding process starts from the 1st loop at the bottom layer, then followed by 2nd loop, by 3rd loop, and so on. Once the fiber reaches the other wall, it will move up to the next layer and continue winding on the 2nd layer. This process would continue until the full length (e.g., 50 meters) of the fiber is wound on the spool. Throughout the winding process, the fiber can be wound tightly to ensure a consistent bending radius.

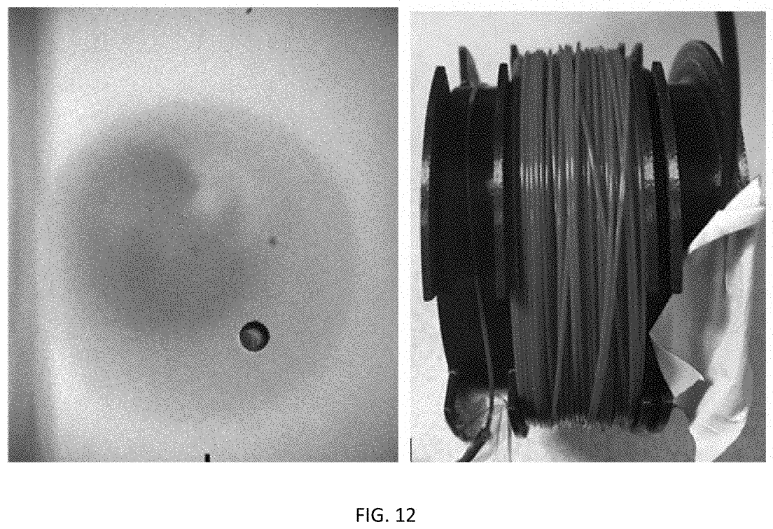

FIG. 12 provides an image of a loosely-wound fiber spool (right panel) and an image (left pane) collected by that loosely-wound fiber spool. As shown, certain areas of contrast in the image are difficult to discern. Without being bound to any particular theory, the loosely-wound fiber resulted in higher order modes around the center of the beam, poor contrast and appreciable speckle.

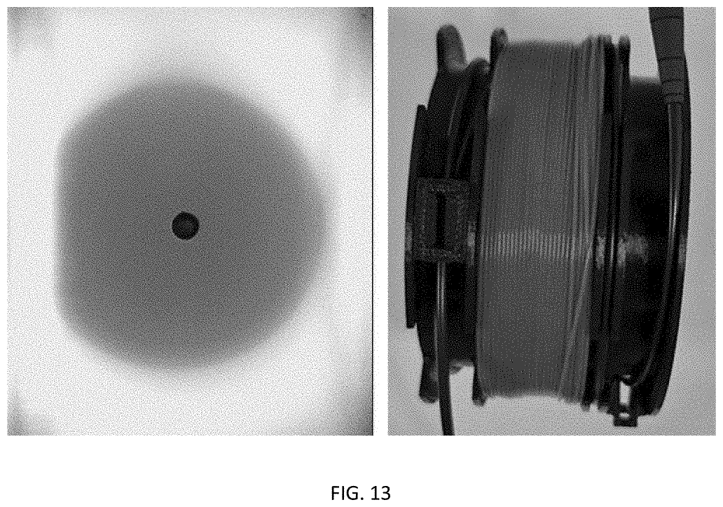

FIG. 13 provides an image of a tightly-wound fiber spool (right panel) and an image (left panel) collected by that tightly-wound fiber spool. As shown (and by comparison to FIG. 13), the image exhibits improved contrast relative to FIG. 12, which figure was made using a loosely-wound fiber spool.

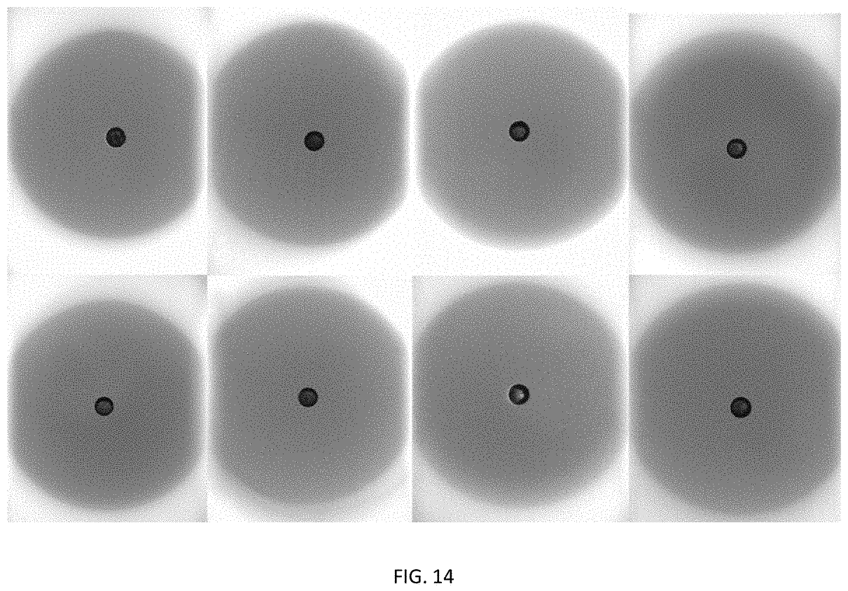

FIG. 14 provides images produced by different fibers that were wound by the techniques described in this disclosure, showing the consistency and repeatability of this technique. Without being bound to any particular theory or embodiment, a tighter winding results in better “mode filtering” that sheds the higher order modes of illumination communicated via the fiber. Again—and without being bound to any particular theory or embodiment—an inconsistent bending radius can in some instances result in propagating higher order modes and increasing the speckle.

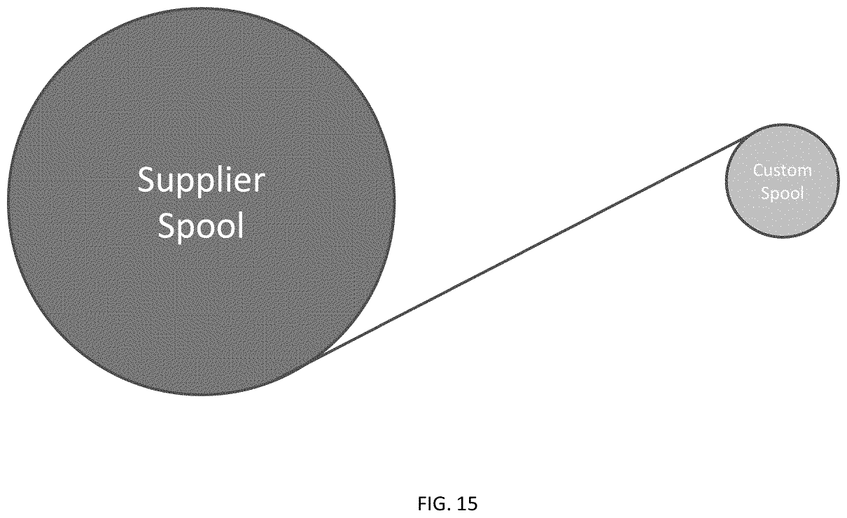

FIG. 15 provides a view of a technique for fabricating wound fibers according to the present disclosure, showing the take-up of optical fiber by a custom spool that is fed the optical fiber by a supplier spool.

Aspects

The following Aspects are illustrative only and do not limit the scope of the present application or the appended claims.

Aspect 1. A light source for capturing an image, comprising: a laser source, the laser source comprising at least one diode; and an optic fiber disposed so as to communicate light pulses having a plurality of modes between the laser source and a target position so as to reduce speckles in a captured image of a target at the target position, at least some of the optic fiber being present in one or more layers wrapped about a spindle, the spindle optionally comprising circumferential walls between which circumferential walls optic fiber is wound, a layer comprising at least one taut winding of the optical fiber.

By “taut” is meant that the fiber optic is free of slack, e.g., that there is essentially no space beneath the fiber optic. An example is shown in FIG. 11, in which windings of the fiber optic (e.g., winding N+3 shown in FIG. 11) are free of slack.

A laser source can include one, two, three, or more diodes, e.g., a plurality of diodes. A diode can be a single mode diode, but can also be a multimode diode. A laser source or sources can provide illumination at one or more wavelengths, e.g., 405, 450, 488, 532, 561, and 640 nm. A diode can also provide illumination at a range of wavelengths, e.g., from 400 to 410 nm.

Aspect 2. The light source of Aspect 1, wherein a layer of the optic fiber comprises at least two taut windings of the optic fiber that are essentially parallel to one another.

As described elsewhere herein, the optic fiber can be disposed about a spindle, but this is not a requirement, as the optic fiber can be disposed within a tray or other feature that accommodates bends or undulations in the optic fiber. Without being bound to any particular theory or embodiment, the optic fiber can be disposed within or even on the housing of an instrument. In this way, a unit can be constructed so as to accommodate a relatively long optic fiber while maintaining a relatively small footprint.

The light source can include a spindle about which the optic fiber is disposed so as to give rise to a bend in the optic fiber. A spindle can be circular in cross-section, but can also be ovoid or even polygonal in cross section. A spindle can be of a constant diameter along its height, but can also be of varying diameter, e.g., conical or frustoconical in configuration. A spindle can taper in the upward direction, but can also be wider at its top and narrower at its bottom. Such a spindle can include, e.g., a constant cross-sectional profile. A spindle can have a changeable cross-section, e.g., by being expandable. In such an embodiment, adjustment of the spindle's cross section (e.g., by expanding the spindle's cross-sectional dimension, by changing the profile of the spindle's cross-section, by reducing the spindle's cross-sectional dimension), one can effect adjustment of the illumination delivered to the target.

Aspect 3. The light source of any one of Aspects 1 to 2, wherein a winding of the optic fiber in an outer layer is essentially parallel to a winding of the optic fiber in an inner layer immediately beneath the outer layer.

A light source according to the present disclosure can also include a processing or controlling train. Such a processing or controlling train can be arranged so as to adjust a setting of the illumination supplied to the target (e.g., by changing a characteristic of the illumination supplied by one or more laser diodes, by changing a feature of the optic fiber) so as to achieve a certain speckle contrast.

Speckle contrast is defined as the standard deviation of the spatial intensity divided by the average intensity measured in an area, and is expressed as a unitless number. Without being bound to any particular theory, a lower speckle contrast figure is typically desired. As but one example, if a first set of settings for the light source gives rise to the desired speckle contrast for a first sample but does not give rise to the desired speckle contrast for the second sample, the processing or controlling train can be configured to adjust a setting of the illumination such that the desired speckle contrast is achieved for the second sample. Although illumination settings can be adjusted in an automated fashion, illumination settings can also be adjusted in a manual fashion.

Aspect 4. The light source of any one of Aspects 1 to 3, wherein windings of the optic fiber in an outer layer do not cross over windings of the optic fiber in an inner layer immediately beneath the outer layer. Such an arrangement is shown in FIG. 10.

Aspect 5. The light source of any one of Aspects 1 to 4, comprising an inner layer of optic fiber comprising a plurality of taut windings of the optic fiber and an outer layer of optic fiber comprising a plurality of taut windings of the optic fiber, and wherein

(i) the plurality of taut windings of the optic fiber in the outer layer are parallel to one another,

(ii) the plurality of taut windings of the optic fiber in the inner layer are parallel to one another, and

(iii) the plurality of taut windings of the optic fiber in the outer layer are parallel to plurality of windings of optic fiber in the inner layer. Such an arrangement is shown in FIG. 11.

Aspect 6. The light source of any one of Aspects 1 to 5, wherein the spindle has a constant cross-sectional dimension.

Aspect 7. The light source of any one of Aspects 1 to 5, wherein the spindle is variable in cross-sectional dimension.

Aspect 8. The light source of any one of Aspects 1 to 7, wherein the spindle has a cross-sectional dimension of from about 1 cm to about 10 cm.

Aspect 9. The light source of any one of Aspects 1 to 8, wherein the light pulses from the laser source are synchronized. As an example, if the laser source comprises three diodes, the light pulses from the three diodes can be synchronized with one another. Synchronization is not a requirement, however.

Aspect 10. The light source of any one of Aspects 1 to 9, wherein light from the laser source is pulsed at approximately 100 nanoseconds to strobe the target. A light pulse can be from about 5 milliseconds to about 1 nanosecond, e.g., from about 1 millisecond to about 1 nanosecond, or from about 0.5 milliseconds to about 10 nanoseconds, or even from about 100 nanoseconds to about 10 nanoseconds.

Aspect 11. The light source of any one of Aspects 1 to 10, further comprising an image capture device configured to capture the captured image of the target, the captured image optionally having an exposure of approximately 6 microseconds. . The image capture train can include a camera (CCD, sCMOS, CMOS) a PMT array, an avalanche photodiode, a photodiode array, or other modules. The image capture train can include a processor configured to effect processing of an image collected by the image capture train.

Aspect 12. The light source of any one of Aspects 1 to 11, wherein the optic fiber is a multimode optic fiber.

Aspect 13. The light source of any one of Aspects 1 to 12, wherein the optic fiber is a high numeric aperture optic fiber. As an example, a fiber having a numeric aperture of greater than about 0.22 is considered a high numeric aperture optic fiber.

Aspect 14. The light source of any one of Aspects 1 to 13, wherein a numeric aperture of the optic fiber is approximately 0.5. The numeric aperture can be, e.g., from about 0.1 to about 0.5, e.g., from about 0.1 to about 0.5, from about 0.15 to about 0.45, from about 0.2 to about 0.4, from about 0.25 to about 0.35, or even about 0.3.

Aspect 15. The light source of any one of Aspects 1 to 14, wherein the length of the optic fiber is between approximately 2 meters and approximately 75 meters. The fiber can be, e.g., from about 2 to about 75 meters, from about 5 to about 70 meters, from about 10 to about 65 meters, from about 15 to about 60 meters, from about 20 to about 55 meters, from about 25 to about 50 meters, from about 30 to about 45 meters, or even from about 35 to about 40 meters.

Aspect 16. The light source of Aspect 15, wherein the length of the optic fiber is approximately 50 meters.

Aspect 17. The light source of any one of Aspects 1 to 16, wherein the laser source comprises a plurality of laser diodes and wherein each of the plurality of laser diodes is positioned spatially apart from other ones of the plurality of laser diodes.

Aspect 18. The light source of any one of Aspects 1 to 17, wherein the position for the target is spatially separated from the plurality of laser diodes.

Aspect 19. The light source of any one of Aspects 1 to 18, wherein the laser source includes a first laser diode that generates the source light at a predefined wavelength.

Aspect 20. The light source of any one of Aspects 1 to 19, wherein the laser source includes at least one multimode laser diode.

Aspect 21. The light source of any one of Aspects 1 to 20, wherein the laser source includes a plurality of laser diodes, wherein at least one of the plurality of laser diodes generates light at a different wavelength from another of the plurality of laser diodes.

Aspect 22. A method, comprising operating a light source according to any one of Aspects 1 to 21 to illuminate a target. The target can be located within a flow cell, e.g., within a flow cytometer. The target can be moving (e.g., a cell within a flow cytometer), but can also be stationary. For example, the target can be disposed within a microscopy system, e.g., a location on a microscope stage.

Aspect 23. The method of Aspect 22, further comprising collecting an image of the target.

Aspect 24. A method, comprising: placing an optic fiber into optical communication with a source of illumination such that the optic fiber is placed so as to communicate light from the source of illumination to a target disposed at a target location, at least some of the optic fiber being present in one or more layers wrapped about a spindle, the spindle optionally comprising circumferential walls between which optic fiber is wound, and a layer comprising at least one taut winding of the optical fiber.

Aspect 25. The method of Aspect 24, wherein a layer of the optic fiber comprises at least two taut windings of the optic fiber that are essentially parallel to one another.

Aspect 26. The method of any one of Aspects 24 to 25, wherein a winding of the optic fiber in an outer layer is essentially parallel to a winding of the optic fiber in an inner layer immediately beneath the outer layer.

Aspect 27. The method of any one of Aspects 24 to 26, wherein windings of the optic fiber in an outer layer do not cross over windings of the optic fiber in an inner layer immediately beneath the outer layer.

Aspect 28. The method of any one of Aspects 24 to 27, wherein the optic fiber is present as an inner layer of optic fiber comprising a plurality of taut windings of the optic fiber and an outer layer of optic fiber comprising a plurality of taut windings of the optic fiber, and wherein

(i) the plurality of taut windings of the optic fiber in the outer layer are parallel to one another,

(ii) the plurality of taut windings of the optic fiber in the inner layer are parallel to one another, and

(iii) the plurality of taut windings of the optic fiber in the outer layer are parallel to plurality of windings of optic fiber in the inner layer.

Aspect 29. A method for providing source light for generating an image, comprising: generating illumination with one or more laser diodes; and passing the illumination through an optic fiber being present in one or more layers wrapped about a spindle, the spindle optionally comprising circumferential walls between which optic fiber is wound, and a layer comprising at least one taut winding of the optical fiber, the passing performed such that multimode source light is emitted from the optic fiber so as to illuminate a target with the illumination light, the illumination reducing speckles in an image of the target.

Aspect 30. The method of Aspect 29, wherein the illumination is generated by at least two laser diodes that generate light at a different wavelength from one another such that the at least two laser diodes produce the illumination with a plurality of modes.

Aspect 31. The method of any one of Aspects 29 to 30, wherein generating the source light comprises generating synchronized light pulses from the at least one laser diodes.

Aspect 32. The method of any one of Aspects 29 to 31, wherein generating the illumination comprises pulsing at least one of the one or more laser diodes at a period of approximately 100 nanoseconds to strobe the target.

Aspect 33. The method of any one of Aspects 29 to 32, further comprising capturing the image of the target with an image capture device, the image capture device optionally having an exposure of approximately 6 microseconds.

Aspect 34. The method of any one of Aspects 29 to 32, wherein the optic fiber is a multimode optic fiber.

Aspect 35. The method of any one of Aspects 29 to 34, wherein the optic fiber is a high numeric aperture optic fiber.

Aspect 36. The method of Aspect 35, wherein the numeric aperture of the optic fiber is about 0.5.

Aspect 37. The method of any one of Aspects 29 to 36, wherein the length of the optic fiber is from about 2 meters to about 50 meters.

Aspect 38. The method of Aspect 37, wherein the length of the optic fiber is about 50 meters.

Aspect 39. The method of any one of Aspects 29 to 38, wherein the illumination is generated by a plurality of laser diodes, each of the plurality of laser diodes being positioned spatially apart from others of the plurality of laser diodes.

Aspect 40. The method of any one of Aspects 29 to 39, wherein the target is located within a flow cell.

Aspect 41. The method of any one of Aspects 29 to 40, further comprising effecting relative motion between the illumination and the target.

Aspect 42. The method of any one of Aspects 29 to 41, wherein the target is stationary during application of the illumination.

Aspect 43. The method of any one of Aspects 29 to 42, wherein the target is moving during application of the illumination.

Aspect 44. A cytometer, comprising: a flow cell configured to contain one or more particles therein, the flow cell defining a target region; an illumination train comprising at least (1) a laser source that includes at least one diode and (2) an optic fiber in optical communication with the laser source, at least some of the optic fiber being present in one or more layers wrapped about a spindle, the spindle optionally comprising circumferential walls between which circumferential walls optic fiber is wound, and a layer comprising at least one taut winding of the optical fiber.

The cytometer can include one or more of hydrodynamic or sheath fluid focusing and acoustic radiation pressure focusing. Hydrodynamic focusing is known to those of ordinary skill in the art, and an exemplary discussion of acoustic radiation pressure focusing is found in, e.g., US 2020/0072795, by Kaduchak et al.

Aspect 45. The cytometer of Aspect 44, further comprising an image capture device configured to capture an image of a target disposed within the target region while illuminated by illumination from the at least one diode communicated through the optic fiber.

Aspect 46. An imager, comprising: a sample zone configured to contain a sample therein; an illumination train comprising at least (1) a laser source that includes at least one diode and (2) an optic fiber in optical communication with the laser source, at least some of the optic fiber being present in one or more layers wrapped about a spindle, the spindle optionally comprising circumferential walls between which circumferential walls optic fiber is wound, and a layer comprising at least one taut winding of the optical fiber; and an image capture device configured to capture an image of a sample disposed within the sample zone region while illuminated by illumination from the at least one diode communicated through the optic fiber, the imager further optionally comprising a movement train configured to effect relative motion between the sample within the sample zone and illumination from the at least one diode communicated through the optic fiber.

Aspect 47. A light source, comprising: a laser source, the laser source comprising at least one diode; and an optical fiber disposed so as to communicate light between the laser source and an imaging plane so as to lower coherence of the light so as to reduce speckle at the imaging plane, at least some of the optical fiber being bent about a support so as to give rise to a mechanical tension within the optical fiber.

Aspect 48. The light source of Aspect 47, wherein the support is characterized as a spindle.

Aspect 49. The light source of Aspect 47, wherein the support is characterized as a post.

Aspect 50. The light source of any one of Aspects 47 to 49, wherein the support defines a constant cross-sectional dimension.

Aspect 51. The light source of any one of Aspects 47 to 50, wherein the optical fiber comprises at least one winding that encircles the support.

Aspect 52. The light source of Aspect 51, wherein the optical fiber comprises a plurality of windings that encircle the support.

Aspect 53. The light source of Aspect 52, wherein the optical fiber comprises a plurality of layers that encircle the support, each layer comprising a plurality of windings.

Aspect 54. The light source of any one of Aspects 47-53, wherein the light source is configured to give rise to less than about 2% speckle at the imaging plane.

Aspect 55. The light source of Aspect 54, wherein the light source is configured to give rise to less than about 1% speckle at the imaging plane.

Aspect 56. The light source of Aspect 54, wherein the light source is configured to give rise to about 1% speckle at the imaging plane.

Aspect 57. The light source of any one of Aspects 47 to 56, wherein the optical fiber has a long term bend radius, and wherein the optical fiber is bent at a radius less than the long term bend radius.

Aspect 58. The light source of any one of Aspects 47 to 57, wherein the transmission of the light through the optical fiber is from about 60% to about 90%.

Aspect 59. The light source of Aspect 58, wherein the transmission is from about 75% to about 90%.

Aspect 60. The light source of any one of Aspects 47 to 59, wherein the imaging plane is disposed within a flow cell.

Aspect 61. The light source of Aspect 60, wherein the flow cell is comprised in a flow cytometer.

Aspect 62. The light source of any one of Aspects 47 to 61, wherein the mechanical tension maintains the optical fiber in a taut state.

Aspect 63. The light source of any one of Aspects 47 to 62, wherein the laser source provides light as light pulses, the light pulses optionally being synchronized.

Aspect 64. The light source of Aspect 63, wherein light from the laser source is pulsed at approximately 100 nanoseconds to strobe the target.

Aspect 65. The light source of any one of Aspects 47 to 64, further comprising an image capture device configured to capture the captured image of the target, the captured image optionally having an exposure of approximately 6 microseconds.

Aspect 66. The light source of any one of Aspects 47 to 65, wherein the optic fiber is a multimode optic fiber.

Aspect 67. The light source of any one of Aspects 47 to 66, wherein the optic fiber is a high numeric aperture optic fiber.

Aspect 68. The light source of any one of Aspects 47 to 67, wherein a numeric aperture of the optic fiber is approximately 0.5.

Aspect 69. The light source of any one of Aspects 47 to 68, wherein the length of the optic fiber is between approximately 2 meters and approximately 75 meters.

Aspect 70. The light source of Aspect 69, wherein the length of the optic fiber is approximately 50 meters.

Aspect 71. The light source of any one of Aspects 47 to 70, wherein the laser source comprises a plurality of laser diodes and wherein each of the plurality of laser diodes is positioned spatially apart from other ones of the plurality of laser diodes.

Aspect 72. The light source of any one of Aspects 47 to 71, wherein the laser source includes a first laser diode that generates the source light at a predefined wavelength.

Aspect 73. The light source of any one of Aspects 47 to 72, wherein the laser source includes at least one multimode laser diode.

Aspect 74. The light source of any one of Aspects 47 to 73, wherein the laser source includes a plurality of laser diodes, wherein at least one of the plurality of laser diodes generates light at a different wavelength from another of the plurality of laser diodes.

Aspect 75. A method, comprising operating a light source according to any one of Aspects 47 to 74.

Aspect 76. The method of Aspect 75, wherein the operating comprises illuminating one or more particles or cells at the imaging plane.

Aspect 77. The method of Aspect 76, further comprising collecting an image of a target illuminated by the light source and located at the imaging plane.

1-77. (canceled)

78. An imager, comprising:
a sample zone configured to contain a sample therein;
an illumination train comprising at least (1) a laser source and (2) an optic fiber in optical communication with the laser source, at least some of the optic fiber being taut about a spindle, an image capture device configured to capture an image of a sample disposed within the sample zone region while illuminated by illumination from the at least one laser source communicated through the optic fiber.

79. The imager of claim 78, wherein the laser source comprises a multimode diode.

80. The imager of claim 78, wherein the optic fiber has a length of from about 2 to about 75 meters.

81. The imager of claim 78, wherein the optic fiber comprises a first layer of windings of the optic fiber.

82. The imager of clam 81, wherein the optic fiber comprises a second layer of windings of the optic fiber, the second layer being atop the first layer.

83. The imager of claim 82, wherein a winding of optic fiber in the second layer is parallel to a winding of optic fiber in the first layer.

84. The imager of claim 82, wherein a winding of optic fiber in the second layer crosses over a winding of optic fiber in the first layer.

85. A method for reduced-speckle illumination, comprising:
operating a laser source so as to illuminate a sample with illumination communicated from the laser source through a optic fiber that is taut about a spindle.

86. The method of claim 85, wherein the laser source comprises a multimode diode, wherein the fiber optic is a multimode fiber optic, or both.

87. The method of claim 85, wherein the fiber optic comprises a first layer of windings of the optic fiber.

88. The method of claim 85, wherein the optic fiber comprises a second layer of windings of the optic fiber, the second layer being atop the first layer.

89. The method of claim 88, wherein a winding of optic fiber in the second layer is parallel to a winding of optic fiber in the first layer.

90. The method of claim 88, wherein a winding of optic fiber in the second layer crosses over a winding of optic fiber in the first layer.

91. The method of claim 85, wherein the operating the laser source gives rise to less than about 2% speckle at an imaging plane of the sample.

92. The method of claim 85, wherein transmission of the illumination through the optical fiber is from about 60% to about 90%.

93. The method of claim 85, wherein the optic fiber has a length of from about 2 to about 7 meters.

94. A cytometer, comprising:
a flow cell,
the flow cell being configured to communicate a target therein;
an illumination train, the illumination train comprising at least (1) a laser source and (2) an optic fiber in optical communication with the laser source, at least some of the optic fiber being wound about a spindle, the illumination train being operable to illuminate the target in a sample zone with illumination light, the illumination light reducing speckles in an image of the target; and
an image capture device configured to capture an image of a sample disposed within the sample zone region while illuminated by illumination from the at least one laser source communicated through the optic fiber.

95. The cytometer of claim 94, wherein the illumination light gives rise to less than about 2% speckle at an imaging plane of the target.

96. The cytometer of claim 94, wherein the optic fiber has a numerical aperture of from about 0.2 to about 0.55.

97. The cytometer of claim 94, wherein the optic fiber has a length of from about 2 to about 75 meters.
